(19) United States
(12) Patent Application Publication
(10) Pub. No.: US 2017/0052284 A1
(43) Pub. Date: Feb. 23, 2017

(54) Batch Process for Preparing Molded Optical Articles

(71) Applicant: PPG Industries Ohio, Inc., Cleveland, OH (US)

(72) Inventors: Vivek Badarinarayana, Pittsburgh, PA (US); Kevin T. Bivona, Pittsburgh, PA (US); Nina V. Bojkova, Monroeville, PA (US); Charles R. Hickenboth, Cranberry Township, PA (US); Elizabeth A. Horner, Boswell, PA (US); David L. Lusher, II, Cheswick, PA (US)

(21) Appl. No.: 15/241,149

(22) Filed: Aug. 19, 2016

Related U.S. Application Data
(60) Provisional application No. 62/208,207, filed on Aug. 21, 2015.

(51) Int. Cl. G02B 1/04; C08G 18/16; C08G 18/24; C08G 18/18; C08G 18/38; C08G 18/75

(52) U.S. Cl. CPC G02B 1/041; C08G 18/3876; C08G 18/758; C08G 18/242; C08G 18/18; C08G 18/168

(57) ABSTRACT

A batch process for preparing a molded optical article includes introducing (i) a dithiol component or (ii) a polyisocyanate component into a reaction vessel; adding a first catalyst of organotin halide to form a first reaction mixture; heating the first reaction mixture; introducing a second catalyst of tertiary amine to the first reaction mixture; mixing a polyisocyanate (ii) into the reaction vessel containing the first reaction mixture if dithiol (i) was first added, or mixing a dithiol (i) into the first reaction mixture if the polyisocyanate (ii) was first added, to form a second reaction mixture; filling a mold with the second reaction mixture to provide a filled mold to form a molded optical article. The molar ratio of elemental tin present in the first catalyst to tertiary amine compound present in the second catalyst ranges from 0.04:1 to 0.29:1.

### CROSS-REFERENCE TO RELATED APPLICATION

This application claims the benefit of priority from U.S. Provisional Application No. 62/208,207, filed Aug. 21, 2015, which is incorporated herein in its entirety.

### FIELD OF THE INVENTION

The present invention relates generally to a batch process for preparing molded optical articles as well as molded articles prepared therefrom.

### BACKGROUND OF THE INVENTION

Optical articles, such as optical lenses, are typically prepared through a casting process. The casting process generally involves mixing chemical materials to form a reaction mixture, adding the mixture to a mold, and curing the mixture to form an optical article. This casting process can be performed as a continuous process or as a batch process.

In a continuous casting process, the chemical materials are continuously mixed and dispensed into a mold. While this process is a fast and efficient method for forming numerous optical articles, there are various drawbacks associated with continuous casting processes. For example, continuous casting processes are expensive due to the capital cost of the equipment. Only specialized equipment designed for this process can be used.

In a batch casting process, a simple reactor like a mixing tank with an agitator can be used. Batch casting processes, therefore, provide better control over the formation of optical articles and are less expensive as compared to continuous casting processes. Despite these benefits, current batch casting processes are known to produce optical articles at lower yields and with more optical defects, such as haze, flow lines, and inclusions. Thus, it is desirable to provide an improved batch casting process for optical articles that minimizes these drawbacks.

### SUMMARY OF THE INVENTION

The present invention is directed to a batch process for preparing a molded optical article that includes (a) introducing a component comprising (i) a dithiol or (ii) a polyisocyanate into a reaction vessel; (b) adding a first catalyst comprising an organotin halide to form a first reaction mixture; (c) heating the first reaction mixture; (d) introducing a second catalyst to the first reaction mixture, wherein said second catalyst comprises a tertiary amine compound; (e) mixing a polyisocyanate (ii) into the reaction vessel containing the first reaction mixture if a dithiol (i) was added in (a), or mixing a dithiol (i) into the first reaction mixture if a polyisocyanate (ii) was added in (a), to form a second reaction mixture, wherein the molar ratio of elemental tin present in the first catalyst to tertiary amine compound present in the second catalyst ranges from 0.04:1 to 0.29:1; and filling a mold with the second reaction mixture to provide a filled mold to form a molded optical article.

The present invention is also directed to a lens prepared by the batch process.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

All documents, such as, but not limited to, issued patents and patent applications, referred to herein, and unless otherwise indicated, are to be considered to be “incorporated by reference” in their entirety.

As used herein, molecular weight values of polymers, such as weight average molecular weights (Mw) and number average molecular weights (Mn), are determined by gel permeation chromatography using appropriate standards, such as polystyrene standards, and glass transitions temperatures (Tg) are determined using differential scanning calorimetry (DSC) or dynamic mechanical analysis (DMA).

As used herein, polydispersity index (PDI) values represent a ratio of the weight average molecular weight (Mw) to the number average molecular weight (Mn) of the polymer (i.e., Mw/Mn).

As used herein, the term “active hydrogen-functional compound” refers to a compound having a functional group containing a hydrogen atom that displays a significant degree of reactivity, such as towards an isocyanate group (NCO). Non-limiting examples of active hydrogen-functional groups include hydroxyls, primary amines, secondary amines, thiols (also referred to as mercaptans), and combinations thereof.

As used herein, the term “isocyanate-functional compound” refers to a compound having a functional group containing an isocyanate (NCO). Further, a “polyisocyanate” refers to a molecule comprising more than one isocyanate (NCO) functional group.

As used herein, the term “polymer” means homopolymers (e.g., prepared from a single monomer species), copolymers (e.g., prepared from at least two monomer species), and graft polymers.

As used herein, recitations of “linear or branched” groups, such as linear or branched alkyl, are herein understood to include a methylene group or a methyl group; groups that are linear, such as linear C₂-C₃₆ alkyl groups; and groups that are appropriately branched, such as branched C₃-C₃₆ alkyl groups.

As used herein, recitations of “optionally substituted” group, means a group, including, but not limited to, alkyl group, cycloalkyl group, heterocycloalkyl group, aryl group, and/or heteroaryl group, in which at least one hydrogen thereof has been optionally replaced or substituted with a group that is other than hydrogen, such as, but not limited to, halo groups (e.g., F, Cl, I, and Br), hydroxyl groups, ether groups, thiol groups, thio ether groups, carboxylic acid groups, carboxylic acid ester groups, phosphoric acid groups, phosphoric acid ester groups, sulfonic acid groups, sulfonic acid ester groups, nitro groups, cyano groups, hydrocarbyl groups (including but not limited to alkyl; alkenyl; alkynyl; cycloalkyl, including poly-fused-ring cycloalkyl and polycycloalkyl; heterocycloalkyl; aryl, including hydroxyl substituted aryl, such as phenol, and including poly-fused-ring aryl; heteroaryl, including poly-fused-ring heteroaryl; and aralkyl groups), and amine groups, such as N(R₁₁′)(R₁₂′) where R₁₁′ and R₁₂′ can each be independently selected from hydrogen, linear or branched C₁-C₂₀ alkyl, C₃-C₁₂ cycloalkyl, C₃-C₁₂ heterocycloalkyl, aryl, and heteroaryl.

The term “alkyl” as used herein, means linear or branched alkyl, such as, but not limited to, linear or branched C₁-C₂₅ alkyl, or linear or branched C₁-C₁₀ alkyl, or linear or branched C₂-C₁₀ alkyl. Examples of alkyl groups from which the various alkyl groups of the present invention can be selected from, include, but are not limited to, those recited previously herein. Alkyl groups of the various compounds of the present invention can include one or more unsaturated linkages selected from —CH═CH— groups and/or one or more —C≡C— groups, provided the alkyl group is free of two or more conjugated unsaturated linkages. The alkyl groups can be free of unsaturated linkages, such as CH═CH groups and —C≡C— groups.

The term “cycloalkyl” as used herein means groups that are appropriately cyclic, such as, but not limited to, C₃-C₁₂ cycloalkyl (including, but not limited to, cyclic C₅-C₇ alkyl) groups. Examples of cycloalkyl groups include, but are not limited to, those recited previously herein. The term “cycloalkyl” as used herein also includes bridged ring polycycloalkyl groups (or bridged ring polycyclic alkyl groups), such as, but not limited to, bicyclo[2.2.1]heptyl (or norbornyl) and bicyclo[2.2.2]octyl; and fused ring polycycloalkyl groups (or fused ring polycyclic alkyl groups), such as, but not limited to, octahydro-1H-indenyl, and decahydronaphthalenyl.

The term “heterocycloalkyl” as used herein means groups that are appropriately cyclic (having at least one heteroatom in the cyclic ring), such as, but not limited to, C₃-C₁₂ heterocycloalkyl groups or C₅-C₇ heterocycloalkyl groups, and which have at least one heteroatom in the cyclic ring, such as, but not limited to, O, S, N, P, and combinations thereof. Examples of heterocycloalkyl groups include, but are not limited to, imidazolyl, tetrahydrofuranyl, tetrahydropyranyl, and piperidinyl. The term “heterocycloalkyl” as used herein can also include bridged ring polycyclic heterocycloalkyl groups, such as, but not limited to, 7-oxabicyclo[2.2.1]heptanyl; and fused ring polycyclic heterocycloalkyl groups, such as, but not limited to, octahydrocyclopenta[b]pyranyl, and octahydro 1H isochromenyl.

As used herein, the term “aryl” includes C₅-C₁₈ aryl, such as C₅-C₁₀ aryl (and includes polycyclic aryl groups, including polycyclic fused ring aryl groups). Representative aryl groups include, but are not limited to, phenyl, naphthyl, anthracenyl, and triptycenyl.

The term “heteroaryl”, as used herein means aryl groups having at least one heteroatom in the ring and includes, but is not limited to, C₅-C₁₈ heteroaryl, such as, but not limited to, C₅-C₁₀ heteroaryl (including fused ring polycyclic heteroaryl groups) and means an aryl group having at least one heteroatom in the aromatic ring, or in at least one aromatic ring in the case of a fused ring polycyclic heteroaryl group. Examples of heteroaryl groups include, but are not limited to, furanyl, pyranyl, pyridinyl, isoquinoline, and pyrimidinyl.

As used herein, the term “fused ring polycyclic-aryl-alkyl group” and similar terms, such as fused ring polycyclic-alkyl-aryl group, fused ring polycyclo-aryl-alkyl group, and fused ring polycyclo-alkyl-aryl group means a fused ring polycyclic group that includes at least one aryl ring and at least one cycloalkyl ring that are fused together to form a fused ring structure. For purposes of non-limiting illustration, examples of fused ring polycyclic-aryl-alkyl groups include, but are not limited to, indenyl, 9H-flourenyl, cyclopentanaphthenyl, and indacenyl.

The term “aralkyl” as used herein includes, but is not limited to, C₆-C₂₄ aralkyl, such as, but not limited to, C₆-C₁₀ aralkyl, and means an aryl group substituted with an alkyl group. Examples of aralkyl groups include, but are not limited to, those recited previously herein.

Further, the term “alkylene” refers to a linear or branched divalent hydrocarbon radical. The alkylene group may include, but is not limited to, a linear or branched C₁-C₃₀ divalent hydrocarbon radical, or linear or branched C₁-C₂₀ divalent hydrocarbon radical, or linear or branched C₁-C₁₀ divalent hydrocarbon radical. Alkylene groups of the various compounds of the present invention can include one or more unsaturated linkages selected from —CH═CH— groups and/or one or more —C≡C— groups, provided the alkylene group is free of two or more conjugated unsaturated linkages. Alternatively, the alkylene groups are free of any unsaturated linkages, such as CH═CH groups and —C≡C— groups.

The term “curable”, “cure”, “cured” or similar terms, as used in connection with a cured or curable composition, is intended to mean that at least a portion of the polymerizable and/or crosslinkable components that form the curable composition are at least partially polymerized and/or crosslinked. The degree of crosslinking can range from 5% to 100% of complete crosslinking. The degree of crosslinking can range from 30% to 95%, such as 35% to 95%, or 50 to 95%, or 50% to 85% of full crosslinking. The degree of crosslinking can range between any combination of the previously stated values, inclusive of the recited values, and can be determined in accordance with art-recognized methods, such as, but not limited to, solvent-extraction methods.

The terms “optical”, “optically clear”, or like terms mean that the specified material, e.g., substrate, film, coating, etc., exhibits a light transmission value (transmits incident light) of at least 4%, and exhibits a haze value of less than 1%, e.g., a haze value of less than 0.5%, when measured at 550 nanometers by, for example, a Haze Gard Plus Instrument.

As previously described, the present invention is directed to a batch casting process for preparing a molded optical article. As used herein, a “batch casting process” refers to a casting process that uses a particular quantity of chemical materials to prepare molded articles at intermittent periods of time. For purposes of the present invention, the batch casting process is distinguished over a so-called continuous process where ingredients are introduced in a continuous stream into a reaction vessel, consumed or reacted on a continual basis and continuously dispensed. In the presently claimed batch casting process, the ingredients are added to the reaction vessel in predetermined amounts and the resulting distinct batches of reaction products are introduced into molds to form the molded optical articles. With such batch production, ingredients are used to complete a single batch or lot of molded optical articles, then the process begins anew with a fresh batch of raw materials.

The batch casting process according to the present invention can include introducing a first reactive component into a reaction vessel. A “reactive component” refers to a compound capable of undergoing a chemical reaction with itself and/or other compounds. Such reactions can be induced by an external source, such as heat or other means known in the art. The first reactive component introduced into the reaction vessel can include an active-hydrogen functional compound, such as a polythiol, e.g., a dithiol, or an isocyanate-functional compound, such as a polyisocyanate. The reaction vessel used with the batch casting process can include, but is not limited to, a temperature controlled mixing tank. The mixing tank can have and suitable volume, for example, the mixing tank can have a volume of 250 milliliters and up to or beyond 50 gallons with a stirring means, such as a mechanical stirring means.

In the batch process of the present invention, a component comprising (i) an active-hydrogen functional compound, such as a polythiol, e.g., a dithiol, or (ii) an isocyanate-functional compound, such as a polyisocyanate, is introduced into the reaction vessel. The thiol functional groups can be terminal groups and/or pendant groups. As used herein, a “pendant group” refers to a functional group that is attached to and extends out from the backbone of a polymer. The polythiol functional polymer, e.g., dithiol, can also include additional functional groups such as additional active-hydrogen functional groups, as well as cyclic, alkyl, aryl, aralkyl, or alkaryl groups. For example, the polythiol functional polymer can also include pendant hydroxyl groups. In a particular embodiment, the polythiol is a dithiol which further includes one or more hydroxyl groups.

In some examples, the component comprising an active-hydrogen functional compound comprises a polythiol functional thioether polymer. Suitable polythiol functional thioether polymers can be prepared by reacting (1) a compound having at least two thiol functional groups; (2) a compound having triple bond functionality; and, optionally, (3) a compound having at least two double bonds. To provide additional pendant functional groups on the polythiol functional thioether polymer, the compound (2) can comprise a hydroxyl functional compound having triple bond functionality.

The compound (1) having at least two thiol functional groups may comprise mixtures of dithiols, mixtures of higher polythiols, or mixtures of dithiols and higher polythiols. The thiol functional groups are typically terminal groups, though a minor portion (e.g., less than 50% of all groups) may be pendant along a chain. The compound (1) having at least two thiol functional groups may further contain hydroxyl functionality. Non-limiting examples of suitable materials having both hydroxyl and multiple (more than one) thiol groups can include, but are not limited to, glycerin bis(2-mercaptoacetate), glycerin bis(3-mercaptopropionate), 1,3-dimercapto-2-propanol, 2,3 -dimercapto-1-propanol, trimethylolpropane bis(2-mercaptoacetate), trimethylolpropane bis(3-mercaptopropionate), pentaerythritol bis(2-mercaptoacetate), pentaerythritol tris(2-mercaptoacetate), pentaerythritol bis(3-mercaptopropionate), pentaerythritol tris(3-mercaptopropionate), and mixtures thereof.

The polymer having two or more thiol functional groups can also comprise a variety of linkages along the backbone including, but not limited to, ether linkages, ester linkages, sulfide linkages (—S—), polysulfide linkages (—Sₓ—, wherein x is at least 2, or from 2 to 4), ester linkages, amide linkages, and combinations thereof.

Non-limiting examples of suitable dithiols for use in the present invention can include, but are not limited to, 2,5-dimercaptomethyl-1,4-dithiane, dimercaptodiethylsulfide (DMDS), ethanedithiol, 3,6-dioxa-1,8-octanedithiol, ethylene glycol di(2-mercaptoacetate), ethylene glycol di(3-mercaptopropionate), poly(ethylene glycol) di(2-mercaptoacetate) and poly(ethylene glycol) di (3-mercaptopropionate), benzenedithiol, 4-tert-butyl-1,2-benzenedithiol, 4,4′-thiodibenzenethiol, and mixtures thereof.

Other non-limiting examples of dithiols and methods of preparing such materials are described in U.S. Patent Application Publication No. 2012/0286435 at paragraphs [0060] to [0090], which is incorporated by reference herein.

The compound (2) having triple bond functionality may comprise any known alkyne, for example, propargyl alcohol, propargyl chloride, propargyl bromide, propargyl acetate, propargyl propionate, propargyl benzoate, phenyl acetylene, phenyl propargyl sulfide, 1,4-dichloro-2-butyne, 2-butyne-1,4-diol, 3-butyne-2-ol, 2-pentyne, 1-hexyne, 2-hexyne, 3-hexyne, 3-hexyne-2,5-diol, and/or mixtures thereof.

Suitable non-limiting examples of hydroxyl functional compounds having triple bond functionality include propargyl alcohol, 2-butyne-1,4-diol, 3-butyne-2-ol, 3-hexyne-2,5-diol, and/or mixtures thereof. A portion of the hydroxyl functional groups on the compound (2) may be esterified. For example, a portion of the compound (2) may comprise an alkyne-functional ester of a C₁-C₁₂ carboxylic acid such as propargyl acetate, propargyl propionate, propargyl benzoate, and the like. Moreover, in the preparation of the thioether polythiols having pendant hydroxyl groups, a portion of the triple bond-containing compound (2) can comprise, in addition to the hydroxyl functional triple bond-containing compound, a triple-bond-containing compound which contains no hydroxyl functional groups such as those described herein.

In the preparation of the polythiol useful in the present invention, the ratio of thiol functional groups in compound (1) to triple bonds in compound (2) typically ranges from 1.01:1 to 2.0:1, such as 1.3:1 to 2.0:1, and 1.5:1 to 2.0:1. In some instances, the presence of an excess of thiol functional groups may be desirable during the reaction as well as in the reaction product as unreacted compound (1). For example, the presence of excess thiol present during the reaction may enhance the reaction rate. Also unreacted thiol, e.g., in the form of unreacted compound (1), can be present in the final reaction product and, thus, available to subsequently react with, for example, a reactive compound having functional groups reactive with active hydrogens (such as are described below). Thus, in an embodiment of the present invention, the reaction ratio of thiol functional groups in the compound (1) to triple bonds in the compound (2) can range from 1.01:1 to 20:1, such as 1.01:1 to 10:1, or 1.01:1 to 5:1, or 1.5:1 to 5:1, or 1.5:1 to 3:1.

The reactions of compound (1) with triple bond-containing compounds (2) are also described in U.S. Patent Application Publication No. 2012/0286435 at paragraphs [0093] to [0097], which is incorporated by reference herein.

As indicated, the polythiol functional thioether polymer can also be prepared with (3) a compound having at least two double bonds. The compound (3) having at least two double bonds can be chosen from non-cyclic dienes, including straight chain and/or branched aliphatic non-cyclic dienes, non-aromatic ring-containing dienes, including non-aromatic ring-containing dienes, wherein the double bonds can be contained within the ring, or not contained within the ring, or any combination thereof, and wherein the non-aromatic ring-containing dienes can contain non-aromatic monocyclic groups, or non-aromatic polycyclic groups, or combinations thereof; aromatic ring-containing dienes; or heterocyclic ring-containing dienes; or dienes containing any combination of such non-cyclic and/or cyclic groups. The dienes can optionally contain thioether, disulfide, polysulfide, sulfone, ester, thioester, carbonate, thiocarbonate, urethane, or thiourethane linkages, or halogen substituents, or combinations thereof; with the proviso that the dienes contain at least some double bonds capable of undergoing reaction with SH groups of a polythiol, and forming covalent C—S bonds. Often, the compound (3) having at least two double bonds comprises a mixture of dienes that are different from one another.

The compound (3) having at least two double bonds may comprise acyclic non-conjugated dienes, acyclic polyvinyl ethers, allyl-(meth)acrylates vinyl-(meth)acrylates, di(meth)acrylate esters of diols, di(meth)acrylate esters of dithiols, di(meth)acrylate esters of poly(alkyleneglycol) diols, monocyclic non-aromatic dienes, polycyclic non-aromatic dienes, aromatic ring-containing dienes, diallyl esters of aromatic ring dicarboxylic acids, divinyl esters of aromatic ring dicarboxylic acids, and/or mixtures thereof.

Other non-limiting examples of compound (3) are described in U.S. Patent Application Publication No. 2012/0286435 at paragraphs [0105] to [0116], which is incorporated by reference herein.

The reactants (1), (2), and (3) used to form the polythiols may all be reacted together simultaneously (as in a “one pot” process) or mixed together incrementally in various combinations. For example, compound (1) having at least two thiol functional groups may be reacted first with the compound (2) having triple bond functionality in a first reaction vessel to produce a first reaction product, followed by addition of the compound (3), having at least two double bonds to the reaction mixture to react with the first reaction product and yield the polythiol (a) (or addition of the first reaction product to a second reaction vessel containing the compound (3)). As an alternative, the compound (1) may be reacted first with the compound (3) having at least two double bonds to produce a first reaction product, followed by addition of the compound (2) to yield the polythiol. In this embodiment, one may optionally add, simultaneously with, or after the compound (2), an additional compound (3) having at least two double bonds, which may be the same as or different from that reacted earlier with compound (1) to form the first reaction product.

When the compound (1) is combined first with the compound (3), it is believed that they react via a thiol-ene type reaction of the SH groups of (1) with double bond groups of (3). Such reactions may typically take place in the presence of a radical initiator as mentioned above, or in the presence of a base catalyst, particularly when the compound (3) comprises a compound having at least one (meth)acrylate type double bonds. Suitable base catalysts for use in this reaction can vary widely and can be selected from those known in the art. Non-limiting examples can include tertiary amine bases such as 1,8-diazabicyclo[5.4.0]undec-7-ene (DBU) and N,N-dimethylbenzylamine. The amount of base catalyst used can vary widely, but typically it is present in an amount of from 0.001 to 5.0% by weight of the mixture of (1) and (3).

The stoichiometric ratio of the sum of the number of thiol equivalents of all polythiols present (compound (1)) to the sum of the number of equivalents of all double bonds present (including alkyne functionality effective as two double bond equivalents as discussed above) is greater than 1:1. In non-limiting embodiments, said ratio can be within the range of from greater than 1:1 to 3:1, or from 1.01:1 to 3:1, or from 1.01:1 to 2:1, or from 1.05:1 to 2:1, or from 1.1:1 to 1.5:1, or from 1.25:1 to 1.5:1.

Various methods of reacting polyvinyl ether monomers and one or more dithiol materials are described in detail in U.S. Pat. No. 6,509,418 B1, column 4, line 52 through column 8, line 25, which disclosure is herein incorporated by reference. Various methods of reacting allyl sulfide and dimercaptodiethylsulfide are described in detail in WO 03/042270, page 2, line 16 to page 10, line 7, which disclosure is incorporated herein by reference. Various methods for reacting a dithiol and an aliphatic, ring-containing non-conjugated diene in the presence of free radical initiator are described in detail in WO 01/66623A1, from page 3, line 19 to page 6, line 11, the disclosure of which is incorporated herein by reference.

Compounds (1) and (3) can be reacted under various reaction conditions such as those described in U.S. Patent Application Publication No. 2012/0286435 at paragraphs [0121] to [0116], which is incorporated by reference herein. Further, the stoichiometric ratio of the sum of the number of equivalents of triple bond functional groups in compound (2) to the sum of the number of equivalents of double bonds in compound (3) is often within the range of from 0.01:0.99 to 1.00:0, or from 0.10:0.90 to 1.00:0, or from 0.20:0.80 to 1.00:0.

Any of the polythiols described herein, when reacted with a reactive compound having functional groups that are reactive with active hydrogens in accordance with the process of the present invention, can produce a polymerizate having a refractive index of at least 1.50, or at least 1.52, or at least 1.55, or at least 1.60, or at least 1.65, or at least 1.67. Additionally, the polythiol, when reacted in accordance with the process of the present invention with a reactive compound having functional groups that are reactive with active hydrogens, can produce a polymerizate having an Abbe number of at least 30, or at least 35, or at least 38, or at least 39, or at least 40, or at least 44. The refractive index and Abbe number can be determined by methods known in the art such as American Standard Test Method (ASTM) Number D 542-00, using various known instruments. The refractive index and Abbe number can also be measured in accordance with ASTM D 542-00 with the following exceptions: (i) test one to two samples/specimens instead of the minimum of three specimens specified in Section 7.3; and (ii) test the samples unconditioned instead of conditioning the samples/specimens prior to testing as specified in Section 8.1. Further, an Atago model DR-M2 Multi-Wavelength Digital Abbe Refractometer can be used to measure the refractive index and Abbe number of the samples/specimens.

Further, any of the polythiols described herein, including the dithiols, when reacted in accordance with the process of the present invention with a reactive compound having functional groups that are reactive with active hydrogens, such as a polyisocyanate, can produce a polymerizate having a Martens hardness of at least 20 N/mm², or often at least 50, or more often between 70 and 200. Such polymerizates are typically not elastomeric; i.e., they are not substantially reversibly deformable (e.g., stretchable) due to their rigidity and do not typically exhibit properties characteristic of rubber and other elastomeric polymers.

When a dithiol (i) is introduced into the reaction vessel in (a), additional hydroxyl-functional compounds also may be introduced. Non-limiting examples of suitable hydroxyl-functional compounds can include compounds with at least two primary and/or secondary hydroxyl groups (also referred to herein as a “polyol”). Suitable polyols include diols such as glycols and higher polyols. Hydroxyl functional polyesters as are known to those skilled in the art are also suitable for use. Such compounds also can include polyether glycols and polyester glycols having a number average molecular weight of at least 200 grams/mole, or at least 300 grams/mole, or at least 750 grams/mole; or no greater than 1,500 grams/mole, or no greater than 2,500 grams/mole, or no greater than 4,000 grams/mole.

As previously mentioned, the component introduced into the reaction vessel in (a) according to the present invention can comprise (ii) an isocyanate-functional compound, such as a polyisocyanate. The polyisocyanates can include modified polyisocyanates. The term “modified” means that the polyisocyanates are changed in a known manner to introduce additional groups. Non-limiting examples of suitable modified polyisocyanates include, but are not limited to, polyisothiocyanates.

Suitable polyisocyanates for use in the present invention can include, but are not limited to, polymeric and C₂-C₂₀ linear, branched, cyclic and aromatic polyisocyanates. Suitable polyisothiocyanates for use in the present invention can include, but are not limited to, polymeric and C₂-C₂₀ linear, branched, cyclic and aromatic polyisothiocyanates.

Non-limiting examples of suitable polyisocyanates and polyisothiocyanates can include polyisocyanates having at least two isocyanate groups; polyisothiocyanates having at least two isothiocyanate groups; mixtures thereof; and combinations thereof, such as a material having isocyanate and isothiocyanate functionality.

Further non-limiting examples of polyisocyanates can include aliphatic polyisocyanates, cycloaliphatic polyisocyanates, wherein one or more of the isocyanato groups are attached directly to the cycloaliphatic ring, cycloaliphatic polyisocyanates, wherein one or more of the isocyanato groups are not attached directly to the cycloaliphatic ring, aromatic polyisocyanates, wherein one or more of the isocyanato groups are attached directly to the aromatic ring, and aromatic polyisocyanates, wherein one or more of the isocyanato groups are not attached directly to the aromatic ring. When an aromatic polyisocyanate is used, general care should be taken to select a material that does not cause the final reaction product to color (e.g., yellow).

Examples of suitable polyisocyanates can include, but are not limited to, DESMODUR N 3300 (hexamethylene diisocyanate trimer) and DESMODUR N 3400 (60% hexamethylene diisocyanate dimer and 40% hexamethylene diisocyanate trimer), which are commercially available from Bayer Corporation.

The polyisocyanate can include dicyclohexylmethane diisocyanate and isomeric mixtures thereof. As used herein and the claims, the term “isomeric mixtures” refers to a mixture of the cis-cis, trans-trans, and cis-trans isomers of the polyisocyanate. Non-limiting examples of isomeric mixtures for use in the present invention can include the trans-trans isomer of 4,4′-methylenebis(cyclohexyl isocyanate), hereinafter referred to as “PICM” (paraisocyanato cyclohexylmethane), the cis-trans isomer of PICM, the cis-cis isomer of PICM, and mixtures thereof.

Additional aliphatic and cycloaliphatic diisocyanates that can be used include 3-isocyanato-methyl-3,5,5-trimethyl cyclohexyl-isocyanate (“isophorone diisocyanate” or “IPDI”) which is commercially available from Arco Chemical, norbornene diisocyanate, meta-tetramethylxylylene diisocyanate (1,3-bis(1-isocyanato-1-methylethyl)-benzene) which is commercially available from Cytec Industries Inc. as TMXDI® (Meta) Aliphatic Isocyanate, and m-xylylene diisocyanate (MXDI). Mixtures of any of the foregoing may also be used.

Further non-limiting examples of suitable polyisocyanates and polyisothiocyanates can include aliphatic polyisocyanates and polyisothiocyanates; ethylenically unsaturated polyisocyanates and polyisothiocyanates; alicyclic polyisocyanates and polyisothiocyanates; aromatic polyisocyanates and polyisothiocyanates, wherein the isocyanate groups are not bonded directly to the aromatic ring, e.g., m-xylylene diisocyanate; aromatic polyisocyanates and polyisothiocyanates, wherein the isocyanate groups are bonded directly to the aromatic ring, e.g., benzene diisocyanate; aliphatic polyisocyanates and polyisothiocyanates containing sulfide linkages; aromatic polyisocyanates and polyisothiocyanates containing sulfide or disulfide linkages; aromatic polyisocyanates and polyisothiocyanates containing sulfone linkages; sulfonic ester-type polyisocyanates and polyisothiocyanates, e.g., 4-methyl-3-isocyanatobenzenesulfonyl-4′-isocyanato-phenol ester; aromatic sulfonic amide-type polyisocyanates and polyisothiocyanates; sulfur-containing heterocyclic polyisocyanates and polyisothiocyanates, e.g., thiophene-2,5-diisocyanate; halogenated, alkylated, alkoxylated, nitrated, carbodiimide modified, urea modified, and biuret modified derivatives of polyisocyanates thereof; and dimerized and trimerized products of polyisocyanates thereof.

Other non-limiting examples of polyisocyanates are described in U.S. Patent Application Publication No. 2012/0286435 at paragraphs [0138] to [0144], which is incorporated by reference herein. It is possible to use other compounds that are reactive with the active-hydrogen functional compounds. Non-limiting examples of such compounds are disclosed in U.S. Patent Application Publication No. 2012/0286435 at paragraphs [0145] to [0163], which is incorporated by reference herein.

As indicated, the batch process according to the present invention also includes (b) adding a first catalyst into the reaction vessel with (i) the active-hydrogen functional component, such as dithiol, or (ii) the component comprising an isocyanate-functional compound, such as polyisocyanate, to form a first reaction mixture. The first catalyst can include, but is not limited to, an organotin catalyst and, in particular, an organotin halide catalyst. As used herein, “organotin” refers to a chemical group comprising elemental tin and hydrocarbon substituents. Non-limiting examples of organotin halide catalysts that can used with the present invention include dibutyltin dichloride dimethyltin dichloride, dioctyltin dichloride, di-tert-butyltin dichloride, diphenyltin dichloride, and mixtures thereof.

When the first catalyst is added to the reaction vessel along with the component comprising (i) an active-hydrogen functional compound, such as dithiol, to form a first reaction mixture, the first reaction mixture can be heated in an amount sufficient to substantially dissolve the first catalyst. As used herein, “substantially dissolve” refers to dissolving at least 90 weight % of the total weight of a particular component. In some aspects, the first reaction mixture is heated at a temperature ranging from 30° C. to 50° C., or from 35° C. to 45° C. to substantially dissolve the first catalyst. After heating the first reaction mixture as discussed above, a second catalyst (discussed in detail below) can be immediately added and dissolved into the first reaction mixture.

Alternatively, when the first catalyst is added to the reaction vessel along with a component comprising (ii) an isocyanate functional compound, such as a polyisocyanate, a second catalyst can be added to the reaction mixture before heating the reaction mixture. In such instances, the first reaction mixture is heated in an amount sufficient to substantially dissolve both the first catalyst and the second catalyst. For instance, the first reaction mixture can be heated at a temperature ranging from 30° C. to 50° C., or from 35° C. to 45° C. in order to substantially dissolve the first catalyst and second catalyst.

The second catalyst introduced to the reaction vessel comprises a tertiary amine compound. Non-limiting examples of suitable tertiary amine compounds that can be used as the second catalyst include triethylamine, triisopropylamine, dimethyl cyclohexylamine, N,N-dimethylbenzylamine, and mixtures thereof Suitable tertiary amines are also disclosed in U.S. Pat. No. 5,693,738 at column 10, lines 6-38, the disclosure of which is incorporated herein by reference. Additionally, the second catalyst can further comprise a phosphine compound, an organophosphate ester, or a combination thereof.

Optionally, a mold release agent can also be added and dissolved into the first reaction mixture. As used herein, a “mold release agent” refers to a component that aids in removing a cured composition from a mold. Non-limiting examples of a suitable mold release agent include dibutyl phosphate, dioctyl phosphate, Bis-(2-ethylhexyl)phosphate, Zelec UN a mixture of acidic phosphate esters commercially available from Stepan Company, any of the mold release agents commercially available from Axel Plastics Research Laboratories, Inc. sold under the tradename MOLDWIZ, dimethylphosphate, diethylphosphate, diisopropylphosphate, dibutylphosphate, dioctylphosphate, bis(2-ethylhexyl)phosphate, diisodecylphosphate, methoxyethylethoxy ethylphosphate, methoxyethyl-propoxyethylphosphate, ethoxyethyl-propoxyethyl phosphate, ethoxyethyl-butoxyethyl phosphate, di(methoxyethyl) phosphate, di(ethoxyethyl)phosphate, di(propoxyethyl) phosphate, di(butoxyethyl)phosphate, di(hexyloxyethyl) phosphate, di(decyloxyethyl) phosphate, di(methoxypropyl) phosphate, di(ethoxypropyl)phosphate, di(propoxypropyl)phosphate, and/or mixtures of the same.

After dissolving the first catalyst, the second catalyst, and, optionally, a mold release agent, a second reaction mixture is formed. If a component comprising (i) an active hydrogen-functional compound, such as a dithiol, was introduced into the reaction vessel in (a) as discussed above, then an isocyanate-functional compound, such as a polyisocyanate (ii) is mixed with (i) to form the second reaction mixture. Alternatively, if a component comprising (ii) an isocyanate-functional compound, such as a polyisocyanate, was introduced into the reaction vessel in (a) as discussed above, then an active hydrogen-functional compound, such as a dithiol (i) is mixed with (ii) to form the second reaction mixture. In both of the cases previously described, the second reaction mixture can be formed at a temperature ranging from 25° C. to 80° C., or from 50° C. to 70° C., or from 55° C. to 65° C. The second reaction mixture can be mixed for a time period of up to 10 hours, such as from 5 minutes to 8 hours.

Further, the second catalyst can be mixed with the component comprising (ii) an isocyanate-functional compound (e.g., polyisocyanate) or (i) the component comprising an active-hydrogen functional compound (e.g., dithiol) before adding the first catalyst and the second reactive component. For example, the component comprising (ii) an isocyanate-functional compound (e.g., polyisocyanate) and the second catalyst can be introduced into the reaction vessel first to form the first reaction mixture. The component comprising (i) an active-hydrogen functional compound (e.g., dithiol) and first catalyst, such as an organotin halide compound, then can be mixed into the reaction vessel with the first reaction mixture to form the second reaction mixture.

The second reaction mixture can be mixed under heat until a homogenous mixture is formed. The second reaction mixture can then be cooled to a lower temperature to obtain a desired viscosity. For example, the second reaction mixture can be cooled to obtain a viscosity ranging from 50 cps to 700 cps, or from 50 cps to 500 cps, or from 200 cps to 700 cps, or from 400 cps to 700 cps, as determined by taking a sample from the reaction mixture and then measuring the sample with a plate and cone viscometer Brookfield Model CAP+2000 at a temperature of 22° C. It was found that a viscosity ranging from 200 cps to 700 cps provides a molded optical article, such as a lens, with low flow lines and low haze. Unless otherwise noted, all viscosity values referred to herein in the specification, including the examples and the claims, were determined using the aforementioned method.

The cooled second reaction mixture then can be dispensed or filled into a mold to form a filled mold thereby forming a molded article. The mold can include, but is not limited to, a mold for forming an optical article. Non-limiting examples of suitable optical article molds include various types of lens molds, such as a mold for an ophthalmic lens. Once the second reaction mixture is dispensed or filled into the mold, the second reaction mixture can be heated in the mold for a time and temperature sufficient to cure the second reaction mixture and form a cured molded optical article. The molded optical article thus formed then can be cooled and released from the mold.

In some examples, the second reaction mixture is heated in the mold to a maximum cure temperature ranging from 125° C. to 135° C., such as to a temperature of 130° C. The second reaction mixture can also be heated in the mold at a rate ranging from 0.05° C./minute to 0.22° C./minute, from 0.08° C./minute to 0.22° C./minute, or from 0.10° C./minute to 0.20° C./minute. By heating the second reaction mixture in the mold at these rates, an optical article can be formed at a high yield with minimal optical defects, such as haze, striations or flow lines, and inclusions. The filled mold can be held at the cure temperature for a period of from 1 to 10 hours, such as from 2 to 8 hours, or from 3 to 6 hours.

The components used with the batch casting process described herein can be added at various amounts depending on the reactor vessel size, reactive components used to form the optical article, and the size of the mold in order to provide a high production yield. For instance, the organotin halide catalyst can be added at a particular amount to provide a high production yield, such as a production yield of at least 75%, at least 80%, or at least 85%.

The second catalyst comprising tertiary amine also can be added at a particular amount to provide a high production yield, such as the reaction yields previously described. For example, the second catalyst comprising tertiary amine can be added such that the second reaction mixture comprises from 50 ppm to 1000 ppm of the second catalyst based on the total amount of the second reaction mixture. In some other examples, the second catalyst is added such that the second reaction mixture comprises from 50 ppm to 700 ppm, or from 120 ppm to 700 ppm, or from 80 ppm to 600 ppm, or from 150 ppm to 600 ppm, or from 100 ppm to 500 ppm, or from 200 ppm to 500 ppm, of the second catalyst based on the total amount of the second reaction mixture. The amount of the second catalyst is determined using gas chromatography with flame ionization detector.

In the process of the present invention, the molar ratio of the elemental tin present in the organotin halide of the first catalyst to the tertiary amine present in the second catalyst ranges from 0.04:1 to 0.29:1, such as from 0.04:1 to 0.27:1, or from 0.05:1 to 0.25:1.

Further, the component comprising (i) the active-hydrogen functional compounds (such as dithiol) and the component comprising (ii) the isocyanate-functional compounds (such as polyisocyanate) can be added to form a ratio of total active hydrogen-functional group equivalents to total isocyanate equivalents of from 0.80:1.0 to 1.1:1.0, or from 0.85:1.0 to 1.0:1.0, or from 0.90:1.0 to 1.0:1.0, or from 0.90:1.0 to 0.95:1.0, or from 0.95:1.0 to 1.0:1.0.

It is appreciated that the batch casting process described herein allows for the addition of various components in a stepwise manner (as opposed to continuous addition of components). The stepwise addition of the various components provides better control over the formation of optical articles to help form optical articles at a high yield and with minimal optical defects. For instance, the stepwise batch casting process described herein allows for the heating and cooling of certain components at different temperatures to help form optical articles at a high yield and with minimal optical defects.

Non-limiting examples of optical articles that can be prepared by the process of the present invention include ophthalmic articles such as plano (without optical power) and vision correcting (prescription) lenses (finished and semi-finished) including multifocal lenses (bifocal, trifocal, and progressive lenses); sun lenses, fashion lenses, sport masks, face shields, and goggles. The optical article also may be chosen from glazings such as architectural windows and vehicular transparencies such as automobile or aircraft windshields and side windows.

### EXAMPLES

In the following examples, viscosities were measured using a Brookfield CAP 2000+ Viscometer (available from Brookfield AMETEK, Inc.) at 22° C. using a CAP-01 spindle.

The components in Table 1 were used in the compositions of the Examples and Comparative Examples.

TABLE 1
Materials used in polymerizable compositions
of Examples and Comparative Examples.

| Component | Material |
|---|---|
| Component A | TRIBRID ® component A¹ |
| Component BD | TRIBRID ® component BD² |
| Component E | TRIBRID ® component E³ |

¹A proprietary mixture comprising 4,4′-methylene bis(cyclohexyl isocyanate), polyisocyanate and stabilizer, available from PPG Industries, Inc.
²Proprietary mixture of aliphatic dithiol, available from PPG Industries, Inc.
³A blend of internal mold release agents containing 13.8% triethylamine based on GC-FID analysis, available from PPG Industries, Inc.

### Part 1. Preparation of Lenses

Part 1A. Polyisocyanate First

Examples 1, 2, and 3 were prepared on a 5 kilogram scale. Examples 4 and CE-1 were prepared on a 3 kilogram scale. Example 5 was prepared on a 300 gram scale. For each example, a suitably sized reactor vessel equipped with a stirrer was charged with Component A and a tin compound according to the amounts in Table 2. The mixture was mixed under vacuum (<10 Torr) and heated to 40° C. Component E was added and the mixture stirred an additional 10-15 minutes under vacuum. For Example 3, Component E was added prior to any heating step. Component BD was then added to the mixture followed by heating to 60° C. under vacuum. The reaction mixture was held at 60±2.0° C. and samples were removed from the reactor every 15-20 minutes to determine the viscosity (measured @ 22° C.). Once a viscosity between 50-700 cps was reached, listed in Table 2 as “End Viscosity”, the reaction mixture was cooled to 22° C. then filled into multiple pre-assembled molds. The viscosity at this point is listed in Table 2 as “End Viscosity” and is reported as the viscosity (at 22° C.) at the beginning and end of the time to fill all the molds for a particular example. All molds were finished single vision (FSV), either plus “+” powered (70 mm diameter) or minus “−” powered (80 mm diameter). The filled molds were placed in a pre-programmed oven to be cured. For all examples and comparative example in Table 2, the cure cycle began at 50° C. and ramped to 130° C. over 12 hours (0.11° C./min). The samples were held at 130° C. for 6 hours before cooling to 70° C. over one hour. The cured lenses were then demolded and inspected.

TABLE 2
Compositions and polymerization conditions with polyisocyanate added first

| | Example 1 | Example 2 | Example 3 | Example 4 | Example 5 | CE-6 |
|---|---|---|---|---|---|---|
| Component A | 55 | 55 | 55 | 55 | 55 | 55 |
| (parts) | | | | | | |
| Dimethyltin | 41 | 76 | 128 | 128 | — | 0 |
| dichloride (ppm)¹ | | | | | | |
| Dioctyltin | — | — | — | — | 242 | — |
| dichloride (ppm) | | | | | | |
| Component E | 2200 | 2000 | 2000² | 2000 | 2000 | 2200 |
| (ppm)¹ | | | | | | |
| Component BD | 45 | 45 | 45 | 45 | 45 | 45 |
| (parts) | | | | | | |
| End Viscosity | 219-239 | 208-227 | 245-261 | 475-498 | 228 | 401-520 |
| (cP)³ | | | | | | |
| Casting | 22 | 22 | 22 | 22 | 22 | 22 |
| temperature (° C.) | | | | | | |
| Lenses cast | 15 × (+3) | 20 × (+3) | 15 × (+3) | 15 × (+3) | 5 × (+4) | 40 × (+3) |
| (No. × (power) | 15 × (+5) | 18 × (+6) | 15 × (+6) | 15 × (+6) | 5 × (−5) | 40 × (−2) |
| | | | 10 × (−4) | 10 × (−4) | | 36 × (−3) |

¹amount based on total reaction mixture
²Component E was added prior to heating to 40° C.
³End viscosity was measured at 22° C. Ranges of numbers indicate beginning and end of casting time

Part 1B. Polythiol First

All examples in Table 3 were prepared on a 3 kilogram scale. A reactor vessel equipped with a stirrer was charged with Component BD and dimethyltin dichloride according to the amounts in Table 3. The mixture was mixed under vacuum (<10 Torr) and heated to 40° C. Component E was added and the mixture stirred an additional 10-15 minutes under vacuum. Component A was then added to the mixture followed by heating to 60° C. under vacuum. The reaction mixture was held at 60±2.0° C. and samples were removed from the reactor every 15-20 minutes to determine the viscosity (measured @ 22° C.). Once a viscosity between 50-700 cps was obtained, listed in Table 3 as “End Viscosity”, the reaction mixture was cooled to the casting temperature indicated, then filled into multiple pre-assembled molds. A variety of FSV plus “+” (70 mm diameter), plano “0” (85 mm diameter), and minus “-” (80 mm diameter) powers were included. The filled molds were placed in a pre-programmed oven to be cured. For all examples and comparative examples in Table 3, the cure cycle began at 50° C. and ramped to 130° C. over 12 hours (0.11° C./min). The samples were held at 130° C. for 6 hours before cooling to 70° C. over one hour. The cured lenses were then demolded and inspected.

TABLE 3
Compositions and polymerization conditions
with polythiol added first

| | Exam- | Exam- | Exam- | Exam- | |
|---|---|---|---|---|---|
| | ple 7 | ple 8 | ple 9 | ple 10 | CE-11 |
| Component BD | 45 | 45 | 45 | 45 | 45 |
| (parts) | | | | | |
| Dimethyltin | 41 | 50 | 75 | 128 | 200 |
| dichloride (ppm)¹ | | | | | |
| Component E | 2200 | 2200 | 2000 | 2000 | 2200 |
| (ppm)¹ | | | | | |
| Component A | 55 | 55 | 55 | 55 | 55 |
| (parts) | | | | | |
| End Viscosity (cP)² | 508-544 | 445-466 | 477-558 | 500-616 | 494-683 |
| Casting temperature | 22 | 22 | 35 | 35 | 35 |
| (° C.) | | | | | |
| Lenses cast | 46 x (+) | 30 x (+) | 46 x (+) | 46 x (+) | 36 x (+) |
| No. x (power) | 14 x (0) | 10 x (0) | 14 x (0) | 14 x (0) | 14 x (0) |
| | 34 x (−) | 20 x (−) | 51 x (−) | 34 x (−) | 46 x (−) |

¹amount based on total reaction mixture
²End viscosity was measured at 22° C., regardless of casting temperature. Ranges indicate beginning and end of casting time.

Part 2. Evaluation of Demolded Cast Lenses

Flow lines were detected by visual inspection of each lens using a Bulbtronics Model No. BTX75LIS II lens inspection unit. Flow lines appeared where inhomogeneities in refractive index were present. Lenses with no flow lines, or those with flow lines limited to within 7 mm of the lens edge, were considered Acceptable. Lenses with at least one flow line in the lens farther than 7 mm from the edge were considered Rejected. The percentage of rejects is reported below in Table 4, calculated from the number of rejected lenses compared to the total number of lenses produced.

TABLE 4
Reject rates based on flow line defect.

| | Tin/Amine | Number of Lenses | |
|---|---|---|---|
| | ratio | produced | % Reject |
| Example 1 | 0.062 | 30 | 5 |
| Example 2 | 0.127 | 38 | 0 |
| Example 3 | 0.214 | 40 | 0 |
| Example 4 | 0.214 | 40 | 0 |
| Example 5 | 0.213 | 10 | 0 |
| Example 7 | 0.062 | 94 | 10 |
| Example 8 | 0.076 | 60 | 2 |
| Example 9 | 0.125 | 111 | 2 |
| Example 10 | 0.214 | 96 | 0 |
| CE-6 | 0 | 116 | 53 |
| CE-11 | 0.303 | 66 | 32 |

Whereas particular embodiments of this invention have been described above for purposes of illustration, it will be evident to those skilled in the art that numerous variations of the details of the present invention may be made without departing from the invention as defined in the appended claims.

The invention claimed is:

1. A batch process for preparing a molded optical article comprising:
(a) introducing a component comprising (i) a dithiol or (ii) a polyisocyanate into a reaction vessel;
(b) adding a first catalyst comprising an organotin halide to form a first reaction mixture;
(c) heating the first reaction mixture;
(d) introducing a second catalyst to the first reaction mixture, wherein said second catalyst comprises a tertiary amine compound;
(e) mixing a polyisocyanate (ii) into the reaction vessel containing the first reaction mixture if a dithiol (i) was added in (a), or mixing a dithiol (i) into the first reaction mixture if a polyisocyanate (ii) was added in (a), to form a second reaction mixture,
wherein the molar ratio of elemental tin present in the first catalyst to tertiary amine compound present in the second catalyst ranges from 0.04:1 to 0.29:1; and
(f) filling a mold with the second reaction mixture to provide a filled mold to form a molded optical article.

2. The process of claim 1, wherein the filled mold of (f) is heated at a rate of from 0.02° C./minute and 0.50° C./minute to achieve a cure temperature.

3. The process of claim 2, further comprising holding the filled mold at the cure temperature for a time sufficient to cure the second reaction mixture.

4. The process of claim 1, wherein the dithiol (i) comprises at least one hydroxyl group.

5. The process of claim 1, wherein the polyisocyanate (ii) comprises at least one diisocyanate.

6. The process of claim 3, wherein the filled mold is held at the cure temperature for a period of 3 to 6 hours.

7. The process of claim 1, wherein the first reaction mixture is heated in (c) such that the first catalyst is substantially dissolved.

8. The process of claim 7, wherein the first reaction mixture is heated in (c) to a temperature ranging from 30° C. to 50° C.

9. The process of claim 1, wherein the second reaction mixture in (e) is mixed at a temperature ranging from 25° C. to 80° C.

10. The process of claim 8, further comprising cooling the second reaction mixture after (e) to obtain a viscosity of 50 cps to 700 cps.

11. The process of claim 10, wherein the second reaction mixture is cooled after (e) to obtain a viscosity of 200 cps to 700 cps.

12. The process of claim 1, wherein the molar ratio of elemental tin present in the first catalyst to the tertiary amine present in the second catalyst ranges from 0.05:1 to 0.25:1.

13. The process of claim 2, wherein the cure temperature ranges from 125° C. to 150° C.

14. The process of claim 1, further comprising cooling the filled mold and releasing the article from the mold.

15. The process of claim 1, wherein the mold is a lens mold.

16. The process of claim 1, wherein the second catalyst further comprises a phosphine compound, an organophosphate ester, or a combination thereof.

17. The process of claim 1, wherein the component comprising dithiol (i) is introduced in (a), and (d) occurs immediately after (c).

18. The process of claim 1, wherein the component comprising polyisocyanate (ii) is introduced in step (a), and (d) occurs before step (c).

19. The process of claim 2, further comprising adjusting the temperature of the filled mold of (f) to between 0° C. and 60° C.

20. A lens produced from the process according to claim 1.

21. The lens of claim 20, wherein the lens is an ophthalmic lens.
